(19) United States
(12) Patent Application Publication
(10) Pub. No.: US 2003/0057679 A1
(43) Pub. Date: Mar. 27, 2003

(54) Snowboard apparatus including rotatable binding and method incorporating the same

(76) Inventor: Richard W. Pollmiller, Littleton, CO (US)

Correspondence Address: TIMOTHY J MARTIN, PC, 9250 W 5TH AVENUE, SUITE 200, LAKEWOOD, CO, 80226, US

(21) Appl. No.: 09/966,965

(22) Filed: Sep. 27, 2001

(51) Int. Cl. A63C 9/08; B62M 27/00

(52) U.S. Cl. 280/611; 280/14.21

(57) ABSTRACT

A snowboard and rotatable mount securing a binding thereon are provided. The mount includes a base member affixed to the snowboard by fasteners extending through positioning holes. A coupling member is rotatably disposed in the base member and includes openings to fasten the binding to it. A latch operates to lock and unlock the rotation of the coupling member so that the rider may orient the boot with respect to the board's longitudinal axis. When locked, the boot's longitudinal axis is generally transverse to the board's longitudinal axis in a primary boot position. When unlocked, the rider can rotate the boot so that its longitudinal axis is generally parallel to the board's longitudinal axis in a secondary boot position. A snowboard having first and second bindings is provided with the mount's coupling member attached to the second binding. A method for supporting a binding on a snowboard is also provided.

### FIELD OF THE INVENTION

The present invention generally relates to snowboarding and snowboarding equipment. More particularly, the present invention concerns a mount used to secure a snowboard binding to the surface of a snowboard. The invention specifically concerns a mount having a movable component that gives a snowboard rider the capability of rotating the snowboard binding to selectively position the boot in different positions.

### BACKGROUND OF THE INVENTION

Mountains and mountainous regions exist all over the world and are formed by a variety of different geological processes, including the collision between plates of the earth's crust, volcanic eruptions, and even erosion. The existence of mountains and mountain ranges has had a profound affect upon human history. For example, mountains served as natural strategic barriers with easily defendable mountain passes that protected some developing nations from invading armies. In the United States, for example, many attribute the Western Mountains to the development of the western United States because its mineral rich content lured people to the west with dreams of striking it rich.

Today, mountains continue to exert a great influence over the lives of many people. Mountains continue to be a valuable industrial resource, providing support for the mineral, timber, and agriculture industries. But, perhaps the most significant way in which mountains continue to have an effect on the people of today is through its value as a recreational resource. Many people treasure the large variety of recreational resources that mountains provide. For some, mountains serve as inspiration for works of art such as paintings, songs, and novels. For others, the mountains provide a place to observe and study a large variety of wildlife in their natural habitat. Still, for many others who enjoy outdoor activities, the mountains provide a place for hiking, biking, rafting, camping, and the like.

Perhaps the most popular activities enjoyed by people in the mountains occur during those months when the mountains receive substantial amounts of snowfall. During these months, many participate in such activities as snowshoeing, snow mobiling, skiing, snowboarding, sledding and the like. Of these activities, both skiing and snowboarding share an enormous popularity worldwide and continue to attract more people to the sport each year. In fact, both skiing and snowboarding are events in the Winter Olympics.

One reason for the enormous popularity and attraction to skiing and snowboarding can be attributed to the advancements in technology through the years. For example, people have been skiing for centuries, but it was not until the advent of ski lifts that it became possible for more people to participate because ski lifts provided skiers and their equipment with quick access to the slopes. As more and more people became interested in skiing, the technology of the ski industry rapidly evolved. For example, technological improvements to the composition of ski boots have changed to offer ski boots that are lighter, stronger, and more comfortable. In addition, modifications to the shape and even length of skis have given skiers a variety of different ways in which to use skis and maneuver them on the snow.

As the interest in skiing developed and the ski industry evolved, the sport of snowboarding was introduced. Snowboarding offers yet a new way in which people could enjoy riding the snow through use of the same facilities and resorts that skiers use. Several differences exist between snowboarding and skiing. Perhaps the most noticeable difference between skiing and snowboarding is that a snowboard rider's feet are bound to a single, generally flat board, rather than to a pair of skis, and snowboarding does not involve the use of ski poles. Ironically, it is these differences that constitute some of the disadvantages to snowboarding that a rider faces. For example, once the rider loses forward momentum while riding the snowboard, it becomes difficult for the rider to create a forward movement of the snowboard, primarily because the rider's feet are bound in one position, and the rider has no poles to propel himself/herself forward. Typically, the snowboarder has two options for creating forward movement: first, he/she may remove the board entirely from his/her feet and walk; or in the alternative he/she may remove the back foot from the binding and use the back foot to push the snowboard in a forward direction, similar to the movement of a skateboard; this sometimes is called “skating”.

In most situations, it is easier for the rider to just remove the back foot and “skate” to an inclined location where the rider can once again resume his/her ride down the mountain. Another very common situation in which the rider must typically create forward movement of the board is for approaching and traveling through the ski lift line. Since it is necessary that the front foot of the rider be bound to the board while riding in the ski lift chair, snowboarders typically remove the back foot from the binding and skate to the ski lift line. Once seated in the chair, the board dangles from the attached front boot, while the back boot hangs freely.

Although the snowboard rider is ultimately successful in reaching his/her destination by removing the back foot and “skating” the board forward, the main problem created by this forward movement is the fact that angle at which the front boot remains bound to the board. That is, the front boot remains bound to the board in such a manner that the rider's toes are not pointed in the direction that the board is moving, but instead are pointed in a direction that is generally perpendicular to the movement of the board. Thus, while the back boot is removed from the snowboard and the snowboard is being pushed forward, the snowboarder's front leg and foot are twisted at an awkward angle. In addition, while riding the ski lift to the top of the mountain, the rider's foot and leg are similarly twisted at an awkward angle, while the entire weight of the board hangs completely from the front boot. Consequently, for the duration of ride up the mountain, the snowboard rider must endure the discomfort caused from the awkward angle of the front foot as well as the added discomfort caused by the weight of the board dangling from the front boot.

The above-mentioned problems affect all snowboard users, and perhaps, have their greatest detrimental effect on beginning snowboard users because they are unaccustomed to having their foot and leg twisted at an awkward angle placing them at an increased risk of injury. One solution to this problem is provided in U.S. Pat. No. 6,155,591 (hereinafter the “'591 patent”) to Huffman et al issued Dec. 5, 2000. The '591 patent discloses a snowboard binding that is capable of rotating between different positions to permit the rider to rotate the front boot to a position that is comfortable to the rider when propelling the board forward or while sitting on the ski chair. However, the device disclosed in the '591 patent requires that the snowboard rider use only that binding disclosed in the '591 patent. Consequently, the rider is also limited solely to that style of boot that is capable of attaching to the binding disclosed in the '591 patent.

An alternative solution for adjusting the front boot so as to position it in a comfortable position is disclosed in U.S. Pat. No. 5,791,678 (hereinafter the “'678 patent”) to Perlman issued Aug. 11, 1998. The '678 patent discloses a rotatable boot-binding mount which, unlike the '591 patent, permits the rider to secure various boot bindings to the snowboard. In addition, the '591 patent discloses a rotational plate that is received by the mount, which permits rotation of the front boot and binding. However, one disadvantage to the mount disclosed in the '678 patent is that it appears that the front boot can only be adjusted in specified locking positions.

Thus, what is needed is a device adapted to rotate an already existing binding of the rider so that the rider may freely rotate the boot to a comfortable position while the back foot is removed. The present invention is directed to meeting these needs.

### SUMMARY OF THE INVENTION

It is an object of the present invention to provide a mount adapted to secure an existing boot binding apparatus to a snowboard that will allow the rider to quickly and easily rotate the binding between different positions.

It is another object of the present invention to provide a mount for a snowboard binding that is lightweight.

It is yet another object of the present invention to provide a mount for a snowboard binding that is capable of securing to a snowboard by means of the same method used for attaching the binding to the board and that can be selectively positioned along the length of the snowboard.

A still further object of the present invention is to provide a mount for a snowboard binding that permits the rider the capability of selectively angling the binding relative to the surface of the snowboard to accommodate the riding style of different riders.

According to the present invention, then, an apparatus for snow riding is provided for a rider who wears snowboard boots. Broadly, the apparatus includes an elongate snowboard having a longitudinal board axis, an upper surface adapted to support the rider and a lower surface opposite the upper surface. This snowboard includes a first set of attachment bores formed in the upper surface and a second set of attachment bores formed in the upper surface at a location longitudinally spaced from the first set of attachment bores. A first binding is provided and is adapted to receive a first boot of the rider. This first binding is fixably attached to the upper surface of the snowboard by means of first fasteners that are received by at least some of the attachment bores in the first set. A second binding is adapted to receive a second boot of the rider with this second boot including a longitudinal boot axis. A mount is then disposed on the upper surface of the snowboard in spaced relation to the first binding. This mount includes a base member formed as a plate having a plurality of positioning holes extending therethrough and arranged in an array. The base member is fixedly attached to the upper surface of the snowboard by means of second fasteners received through at least some of the positioning holes that are received by least some of the attachment bores in the second set. A coupling member is mounted on the base member with this coupling member having a plurality of openings adapted to received third fasteners. The second binding is then attached to the coupling member by means of third fasteners that are received in at least some of the openings in the coupling member. This coupling member is movably disposed relative to the base member and is operative to orient the coupling member and the base member between a primary boot position and a secondary boot position. A latch is then associated with the base member and the coupling member. This latch is operative in a locked state to lock the coupling member and the base member against rotation when the coupling is in the primary boot position and is movable to an unlocked state thereby to permit the rider to rotate the coupling member between the primary boot position and the secondary boot position.

In an exemplary embodiment, the coupling member is a disk-shaped plate and the base member is a plate having a circular cavity formed therein that is sized and adapted to receive the coupling member in a nested state. For example, the coupling member and the base member are co-planar flat plates when in the nested state. The coupling member, the base member and the latch member may be formed of a material chosen from metal, plastic and a combination of metal and plastic. Moreover, the array of positioning holes may be such as to permit the base member to be mounted in at least two different orientations relative to the longitudinal axis of the snowboard.

The latch can be provided by a first latch bore that is formed in the base member and a second latch bore formed in the coupling member. The first and second latch bores are positioned to co-axially align with one another when the base member and the coupling member are in the primary boot position. The latch then includes a movable rod disposed in the first latch bore and operative to extend into the second latch bore when in the locked state. This rod can be biased toward the locked state.

From the foregoing, the present invention is also directed to an assembly that is adapted to secure to the support surface of a snowboard. This assembly includes a base member that affixes to the support surface of the snowboard to define a mounted state with this base member having a circular opening formed therein and including a radially inwardly projecting flange. A disk-shaped coupling member is rotatably disposed in the circular opening in the base member to define a nested state. This coupling member is operative to engage the flange. The coupling member has a bottom surface adapted to confront the upper surface of the snowboard such that the coupling member is secured between the flange and the snowboard in the coupled state. The coupling member also has a plurality of openings adapted to receive fasteners thereby to secure a binding thereto. A binding member is then adapted to be mounted to the coupling member and is operative to receive the boot of a rider. Engagement between the coupling member and the base member can be accomplished by a circumferential lip on the coupling member that engages the flange on the base member.

A latch may be associated with the base member and the coupling member. This latch is again operative in the locked state to lock the coupling member and base member against relative rotation when the coupling member is in a first position and is movable to an unlocked state to permit relative rotation between the coupling member and the base member. In this assembly, the latch can again be provided by a first latch bore in the base member and a second latch bore in the coupling member. These first and second latch bores are positioned co-axially to align with one another when the base member and the coupling member are in the primary boot position. A movable rod is disposed on the first latch bore and is operative to extend into the second latch bore when in the locked state.

In greater detail, the first latch bore has a first portion of a first diameter and a first length located adjacent to the coupling member and a second portion of a second diameter that is less than the first diameter and a second length. The rod then includes an enlarged head portion disposed on the first portion of the first latch bore and a shaft portion disposed in the second portion of the first latch bore. The second latch bore is sized and adapted to receive at least part of the head portion of the rod when in the locked state with at least some of the shaft portion projecting outwardly of the second portion of the first latch bore in order to be grasped by the rider's hand. A spring element may, if desired, be disposed in the first portion of the first latch bore and operates to bias the head towards the locked state.

The coupling member and the base member can again be formed of a material chosen from metal, plastic and a combination of the same. The base member, in this embodiment, includes a plurality of positioning holes arranged in an array. This array is such that there is a first pair of holes oriented along a first line and spaced a selected distance apart from one another. A second pair of holes oriented along a second line and spaced the selected distance apart from one another and a third pair of holes oriented along a third line different from the second line and spaced the selected distance apart from one another. Each of the second and third lines are oriented at an angle with respect to the first line whereby the first and second pairs of holes are located in the corners of a first rectangle and whereby the first and third pairs of holes are located at the corners of a second rectangle.

The present invention is also directed to a mount that is adapted to secure to a support surface of a snowboard. In this embodiment, the mount includes a base member and a disk-shaped coupling member of a type described above with respect to the assembly. The additional structure of this mount, absent the binding, is that as described above. The mount can also form the basis for an improvement to a snow riding system that also includes the snowboard and bindings noted above; this is also an aspect of the invention.

Finally, the present invention is also directed to a method of supporting a binding of a boot on a support surface of the snowboard. Broadly, this method includes providing a coupling member having a top surface that is securable to the binding and a bottom surface opposite the top surface. The coupling member is placed so that the bottom surface confronts the support surface of the snowboard. The coupling member is restrained from rotation about a rotational axis that is perpendicular to the support surface while maintaining the bottom surface in confronting relationship to the support surface. The binding is then secured to this coupling member. This method may also include the steps of selectively locking the coupling member in a first rotational position and permitting rotation between the first rotational position and a second rotational position.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a top plan view of a snowboard according to the prior art;

FIG. 2 is a perspective view of a snowboard according to the prior art supporting a pair of bindings and snowboard boots of a rider;

FIG. 3 is a top plan view showing the snowboard of FIG. 1 with one of the boots demounted therefrom so that the snowboarder may operate the snowboard in a “skate” mode;

FIG. 4 is a top plan view, similar to FIG. 3, showing a snowboard apparatus of the present invention utilizing the assembly and mount that allows rotation of a second boot while attached to the snowboard with the first boot being demounted therefrom for a “skating” procedure;

FIG. 5 is a top plan view showing a snowboard binding according to a prior art example;

FIG. 6 is a top plan view of the mount and binding assembly according to the exemplary embodiment of the present invention in a first primary boot position;

FIG. 7 is a top plan view similar to FIG. 6 but showing the mount according to the present invention in a second position rotated from the first primary boot position;

FIG. 8 is a perspective view of the mount according to the exemplary embodiment of the present invention;

FIG. 9 is a cross-sectional view taken about lines 9-9 of FIG. 8;

FIG. 10 is a top view in cross-section showing the coupling member and latch assembly with the latch in the locked state;

FIG. 11 is a top plan view in cross-section, similar to FIG. 10 showing the latch in an unlocked state;

FIG. 12 is a bottom plan view showing the mount of FIGS. 5-11;

FIG. 13 is a top view in partial cross-section showing an alternative latch according to the present invention;

FIG. 14 is an enlarged view showing the latch of FIG. 13 in a locked state; and

FIG. 15 is an enlarged view showing the latch of FIGS. 13 and 14 in the unlocked state.

### DETAILED DESCRIPTION OF THE EXEMPLARY EMBODIMENTS

The present invention is directed to a snowboard apparatus and method that has, as an improvement, a new and useful mount that receives a boot binding to form a mounting assembly that allows for the selected rotation of a rider's boot while mounted to a traditional snowboard. The mount according to the present invention is particularly adapted to retro-fit on existing snowboards and receive existing snow boot bindings. Alternatively, the present mount can be incorporated with its own binding as an assembly and mounted on the snowboard as an improvement to the overall snowboard apparatus.

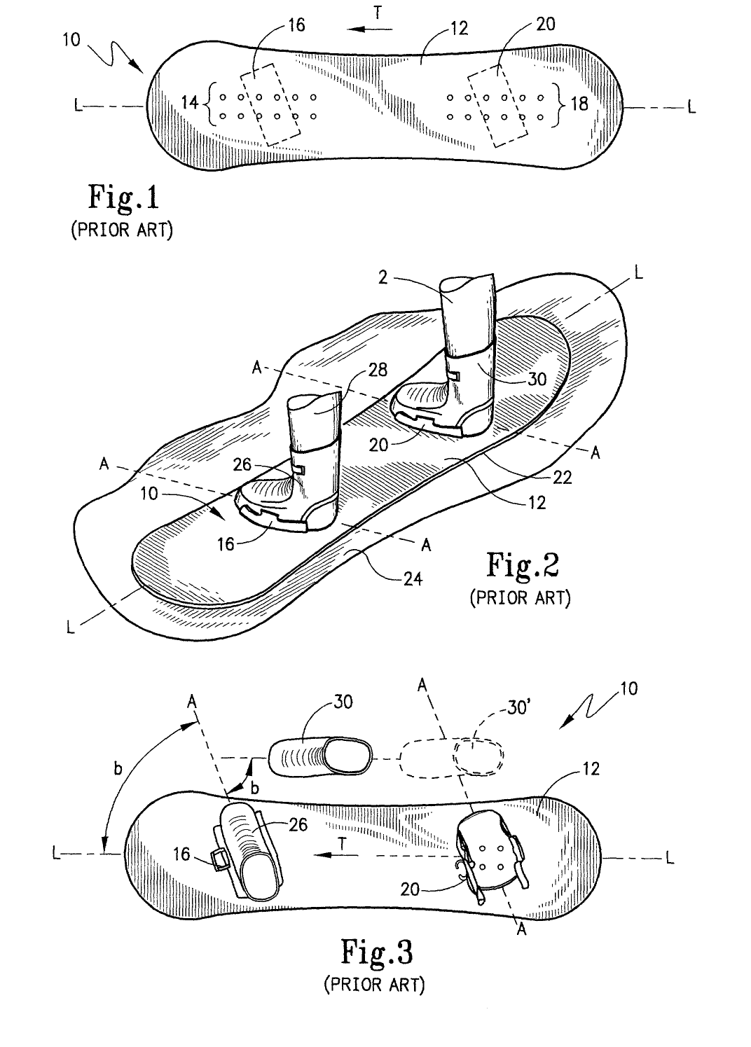

In order to understand the advantages of the present invention, reference may be first made to a traditional snowboard apparatus and bindings. Accordingly, as is shown in FIG. 1, a typical snowboard 10 has an upper surface 12 that is adapted to support a snowboarder during the act of snow riding. Snowboard 10 is elongated and has a longitudinal board axis “L”. Snowboard 10 is designed for forward motion in the direction “T”. It may be noted that the longitudinal axis “L” is parallel to “T”. A first set of attachment bores 18 are formed on a rearward portion of snowboard 10 through the upper surface 12 thereof and are adapted to support a rearward binding 20, also shown in phantom in FIG. 1. A second set of attachment bores 14 are formed at a forward portion of snowboard 10 and are adapted to receive a forward binding 16, shown in phantom in FIG. 1. Attachment bores 14 and 18 are provided to allow bindings 16 and 20 to be mounted in such manner that the spacing therebetween may be varied to accommodate differing stances of a rider. In addition, attachment bores 14 and 18 permit different orientations of the longitudinal boot axis with respect to the longitudinal axis “L” of the snowboard which corresponds to the direction of travel “T”.

With reference, then, to FIG. 2, snowboard 10 is shown with a lower surface 22 supported on a surface 24 such as a snow covered slope. Forward binding 16 is mounted on the snowboard 10 and receives a forward boot 26 that receives a rider's leg 28. Similarly, rearward binding 20 is mounted on snowboard 10 and secures a rearward boot 30 that receives the other leg 32 of the rider. Bindings 16 and 20, as well as their respective boots 26 and 30 are accordingly oriented along a longitudinal boot axis “A”. With reference to FIG. 3, it may be seen that each boot axis “A” is oriented at a large acute angle “b” to the longitudinal board axis “L”. According to the prior art, both the forward binding 16 and the rearward binding 20 are secured to selected holes in the sets of attachment bores 14 and 18 by means of fasteners, such as screws, that extend through the binding and then are received by at least some of the attachment bores.

With continuing reference to FIG. 3, a problem incident of snowboarding is illustrated for situations when there is an insufficient downward slope in the direction of travel for the snowboarder to ride the board under the influence of gravity. In such circumstance, it is necessary for the snowboarder to propel or “skate” the snowboard by disengaging one of his/her boots from its respective binding and then propelling the snowboard 10 by means of a skating action. In FIG. 3, it may be seen that rearward boot 30 has been disengaged from rearward binding 20 and is moved with a stepping action to the position shown. The snow rider then exerts a stepping force so that the snowboard moves in the direction of travel “T” with the rearward boot then moving to the relative position shown in phantom as 30′. This stepping action is continued until the snowboarder advances to a location where the slope is sufficient to again ride the board at which time boot 30 is re-engaged with rearward binding 20. While this action is sufficient to allow the snowboarder to advance the snowboard, it is nonetheless awkward due to the angle “b” between the longitudinal axis “L” and the boot axis “A”. Because of this angular mounting, the snowboarder is placed such that his/her toes are turned inward or in a “pigeon-toed” orientation. Not only is this uncomfortable during the skating motion but also twists the knees and hips of the snow rider in an unnatural position which can cause muscle and joint stress and strain.

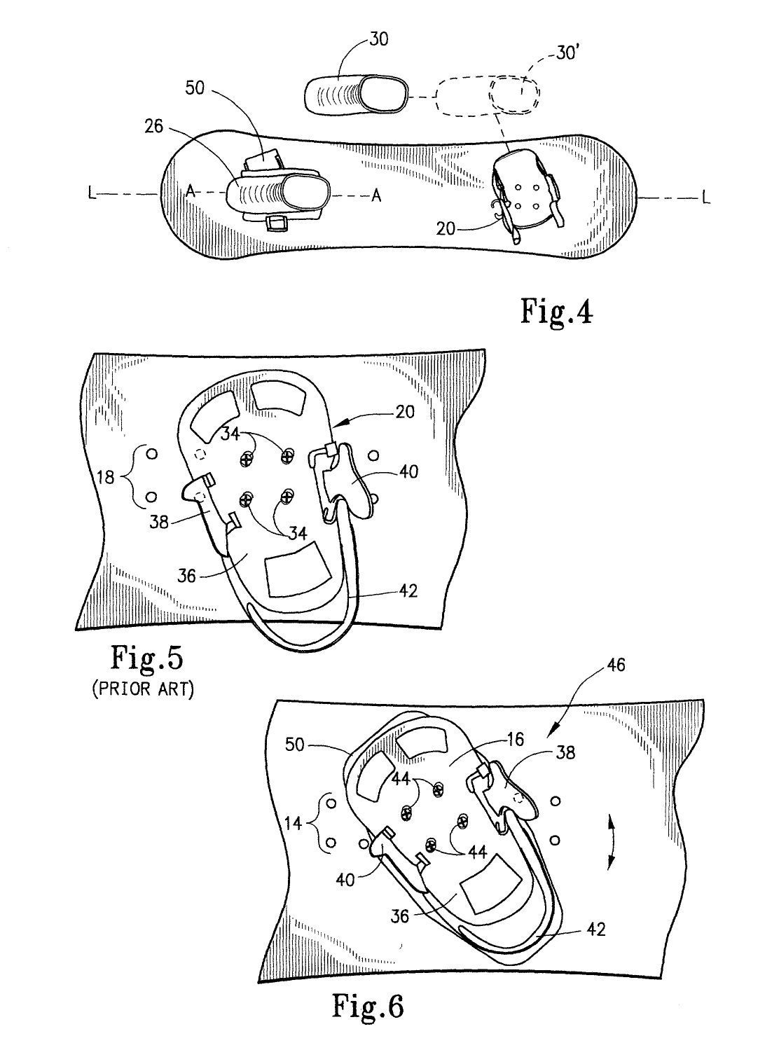

The present invention, on the other hand, is constructed so as to allow the forward boot of the snowboarder to rotate so that the longitudinal boot axis “A” of the forward boot is parallel to the longitudinal axis “L” of the snowboard. This is illustrated in FIG. 4. In this Figure, it may be seen that rearward boot 30 has been removed from the rearward binding 20 just as it has been in FIG. 3 so that a propelling motion can be again applied by a stepping action. Here, however, forward boot 26 has been rotated so that boots 26 and 30 are in a normal walking position. This facilitates the skating of the snowboard in a more comfortable manner since the feet of the snowboarder are now in a natural position, that is, without the toes being pointed inwardly towards one another.

According to the snow riding apparatus of the present invention, then, a traditional or prior art binding is used as the first or rearward binding 20, as is illustrated in FIG. 4. Here, it may be seen that binding 20 is mounted to selected ones of the first set of attachment bores 18 by means of fasteners 34. Binding 20 has a binding plate 36 and left and right mounts 38 and 40 that secure the snowboard boot. A rear strap 42 extends in an arcuate manner between mounts 38 and 40 rearwardly of the boot.

The snow riding apparatus of the present invention provides a new and useful mount 50 introduced in FIGS. 4 and 6 to which second or forward binding 16 is secured by means of fasteners 44. Binding 16 includes binding brackets 38 and 40 as well as an arcuate rear strap 42, similar to that shown in FIG. 5. Accordingly, mount 50 along with binding 16 form an assembly adapted to secure to the support surface of the snowboard and is adapted to support a rider wearing a boot.

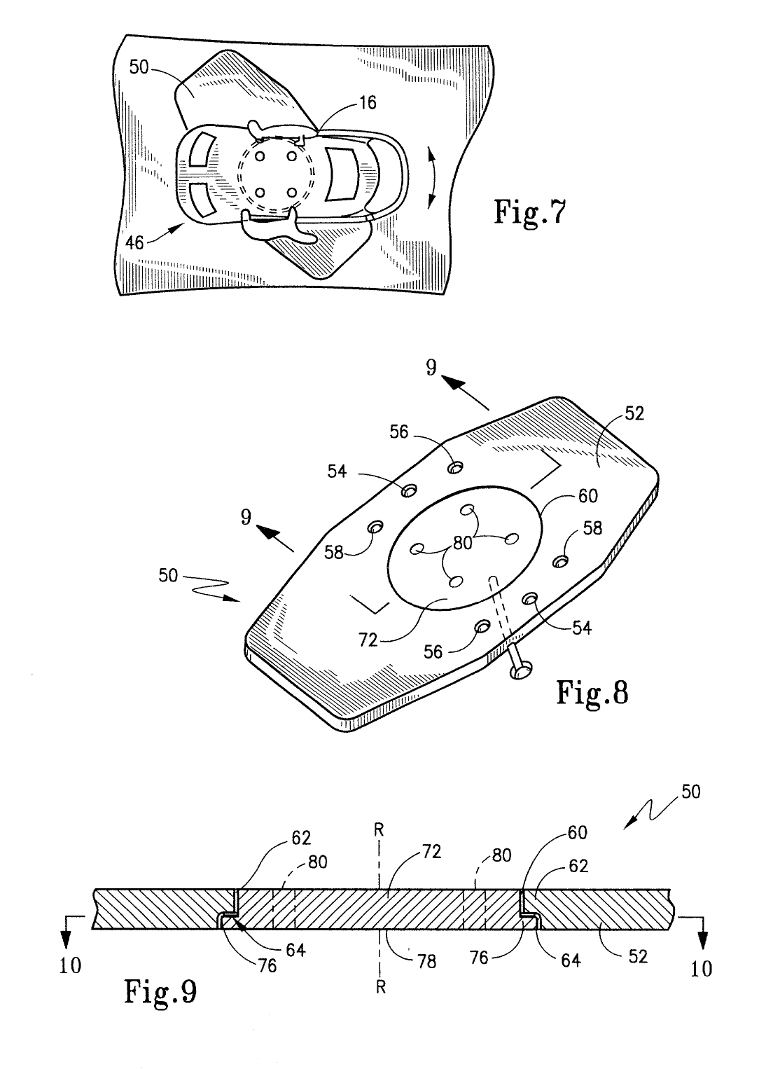

The securing assembly 46 as depicted in FIG. 6 is in a first or primary boot position wherein it may be locked to allow a snowboarder to snow ride as more thoroughly discussed below. However, as depicted in FIG. 7, assembly 46 is in a second secondary boot position permitting the snowboarder to propel the snowboard with a skating motion with both feet aligned in a normal position, as mentioned above. In the second position, forward binding 16 has been rotated with respect to mount 50.

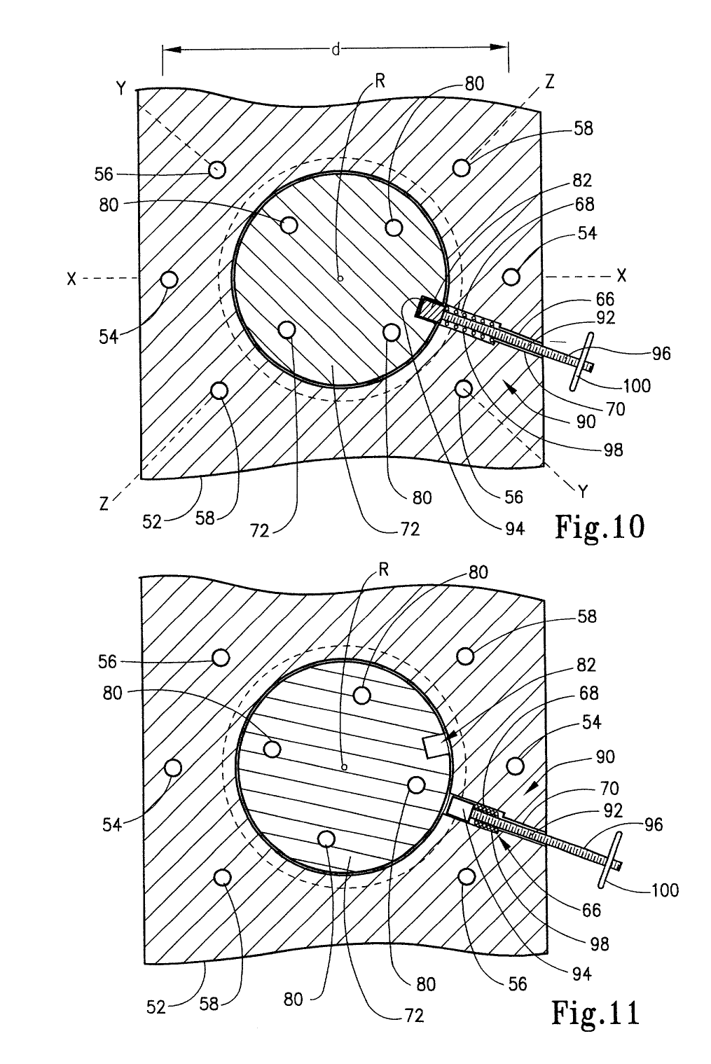

Mount 50 is best shown in FIGS. 8-12. In these figures, it may be seen that mount 50 includes a base member 52 and a disk-shaped coupling member 72 that are formed out of any suitable metal, plastic or a combination of metal and plastic. In this embodiment, each of base member 52 and coupling member 72 are formed out of aluminum. Base member 52 is adapted to be affixed to the upper support surface 12 of snowboard 10 by means of fasteners, such as fasteners 34 or 44. To this end, base member 52 has a plurality of positioning holes that are sized and adapted to receive these fasteners. With reference to FIG. 10, it may be seen that a first pair of holes 54 are oriented along a first line “x” and are spaced a selected distance “d” apart from one another. A second pair of holes 56 are oriented along a second line “y” and are spaced the selected distance “d” apart from one another. A third pair of holes 58 are oriented along a third line “z” that is different from line “y” and are spaced the distance “d” apart from one another. Each of second line “y” and third line “z” is oriented at an angle “a” with respect to first line “x”. Thus, the angle “a” is selected so that the first holes 54 and second holes 56 are located at the corners of an imaginary first rectangle and wherein the first holes 54 and the second holes 58 are located at the corners of a second imaginary rectangle.

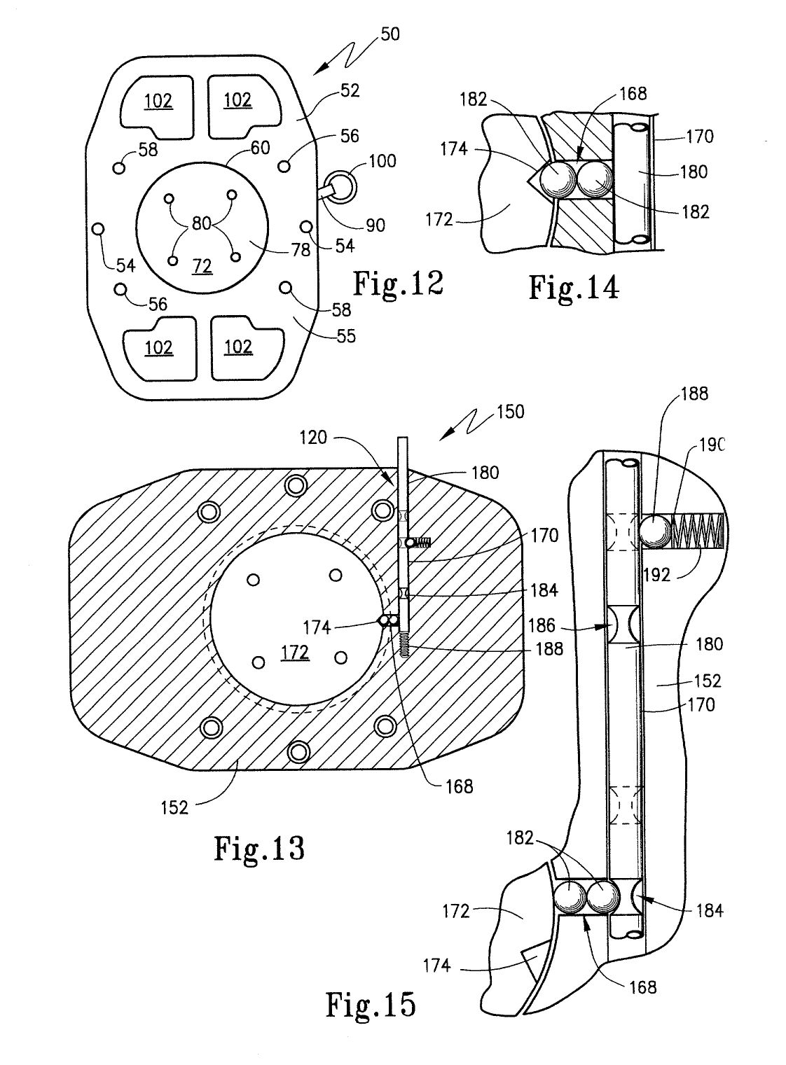

Base member 50 has a centrally located circular opening 60 formed therein. As is seen in FIG. 9, this central opening has a radially inwardly projecting flange 62 that defines an undercut 64. Coupling member 72, on the other hand, has an outwardly projecting lip 74 that forms a shoulder 76 which is engaged by flange 62. Disk-shaped coupling member 72 is shown in FIG. 9 in a nested state where it is disposed in the circular opening 60 in base member 52. Disk-shaped coupling member 72 has a bottom surface 78 that is adapted to confront the upper surface 12 of the snowboard 10 when base member 52 is affixed thereon in a mounted state. The interactions of flange 62 and shoulder 76 then secure the lip 74 of coupling member 72 between the flange 62 and the snowboard 10. When in the nested state, coupling member 72 and base member 52 are generally in a common plane with their upper and lower surfaces being co-extensive and co-planar; that is, coupling member 72 and base member 52 are substantially co-planar flat plates when in the nested relationship. Coupling member 72 has a plurality of threaded openings 80 that are adapted to receive standard threaded fasteners thereby to secure binding 16 thereto. With reference to FIG. 12, it may be seen that the underside of base member 52 has a plurality of cavities 102 formed in the lower surface 55 thereof in order to reduce the amount of metal and weight of mount 50.

Coupling member 72 is rotatable with respect to base member 52 about a rotational axis “R” to allow binding 16 to move between the first position shown in FIG. 6 and the second position shown in FIG. 7. With reference now to FIGS. 10 and 11, it may be seen that a latch 90 is shown with latch 90 having a locked state shown in FIG. 10, to lock coupling member 72 and base member 52 against relative rotation when the coupling member is in the first position. Latch 90 is movable, as is shown in FIG. 11, to an unlocked state that permits relative rotation between the coupling member 72 and the base member 52. To this end, base member 52 has a first latch bore 66 while coupling member 72 has a second latch bore 82 that are positioned to co-axially align with one another, as is shown in FIG. 10, when the base member and the coupling member are in a primary boot position. First latch bore 66 has a first portion 68 that is cylindrical in configuration and has a first diameter and a first length. First portion 68 is located adjacent to coupling member 72 when coupling member 72 and base member 52 are nested together. Latch bore 66 also has a second portion 70 that is cylindrical with a second diameter that is less than the first diameter of the first portion. Second latch bore 82 is cylindrical in shape and extends radially of coupling member 72 and has a diameter that is the same as the diameter of the first portion 68 of latch bore 66.

Latch 90 includes a movable rod 92 that is disposed in latch bores 66 and 82 when in a locked condition. To this end, rod 92 has an enlarged head portion 94 that has a diameter slightly less than the first diameter of first portion 68 of latch bore 66 and of latch bore 82. A shaft portion 96 extends from enlarged head portion 94 exteriorly of second portion 70 of latch bore 66. When in the locked position, shown in FIG. 10, shaft 96 resides in latch bore 66 with enlarged head portion 94 engaging latch bore 82. In the unlocked position, head 94 is withdrawn from latch bore 82 and into first portion 68 of latch bore 66. A spring element 98 is mounted around shaft 96 in first portion 68 of latch bore 66 and is operative to bias enlarged head portion 94 toward the locked state. To facilitate manipulation of latch rod 90, a manually gripable ring 100 is provided at a distal end of shaft portion 96.

In use, it may now be appreciated that mount 50 may be secured to snowboard 10 by fasteners extending through selected holes 54, 56 and 58 with these fasteners being threadably mated into selected ones of the first set of attachment bores 14. By providing the array of holes 54, 56 and 58 as well as the set of attachment bores 14, base member 52 may be mounted in at least two different orientations relative to the longitudinal axis of the snowboard. These holes permit at least three orientations relative to and along axis “L”. This allows a snow rider to either mount the forward binding so that the left or right foot may be placed in the forward position. In addition, the spacing between the forward and rear binding may be selectively adjusted. When in the nested and mounted state, coupling member 72 is rotatable relative to base member 52 but cannot be removed due to the interlocking of flange 62 and lip 74. A traditional binding, such as forward binding 16 is then mounted by fasteners into the threaded openings 80 in coupling member 72. Binding 16 may then be locked in a riding position when latch 90 is in the locked state, that is, when head portion 94 engages latch bore 82.

However, when the snowboarder desires to skate or propel the snowboard 10 when there is a insufficient slope, the snowboarder disengages his/her rearward boot 30 from rearward binding 20 and moves latch 90 to the unlocked state by pulling on ring 100 to cause head portion 94 to move into first portion 68 of latch bore 66 against the biasing of spring element 98. When unlocked, the snowboarder may rotate the forward boot 26 so that the boot axis “A” is parallel to the longitudinal axis “L”of snowboard 10, as is shown in FIG. 4. This may be accomplished without removing forward boot 26 from forward binding 16. To continue snow riding, the snowboarder simply rotates his/her forward boot 26 from the second position back to the first position. At this point, latch 90 automatically re-engages so that it moves to the locked state under the influence of spring element 98. The snowboarder then re-inserts his/her rearward boot 30 in rearward binding 20.

While the above embodiment of mount 50 shows an exemplary embodiment of latch 90, it should be appreciated that other latching structures are possible. Thus, for example, with reference to FIGS. 13-15 it may be seen that a mount 150 employs a latch 120 that is operative to interact between base member 152 and coupling member 172. In this embodiment, base member 152 has a latch bore formed by a first portion 168 that is circular in cross-section and extends radially of coupling member 172. An elongate second portion 170 is circular in cross-section and extends perpendicularly to first portion 168. A latch rod 180 is reciprocally mounted in second portion 170 against the force of biasing spring element 198. A pair of ball bearings 182 are disposed in first portion 168 of the latch bore arrangement and are sized to engage a notch 174 formed in the peripheral edge of coupling member 172. As is shown best in FIGS. 13 and 14, rod 180 has a diameter such that ball bearings 182 are held in a locked state engaging notch 174 so that coupling member 172 is prevented from rotation and is thus in a locked state. However, as is shown in FIG. 15, rod 180 has a first circumferential channel 184 which may be moved into registration with ball bearings 182 so that they move out of engagement with notch 174 thereby to allow coupling member 172 to rotate relative to base member 152. A second circumferential groove 186 is provided on rod 180 and may register with a detent ball 188 that, along with a detent spring 190 is located in a detent bore 192. The detent is engaged when ball bearings 182 are in the locked state. Latch 120 accordingly provides a push rod assembly that allows ball bearings 182 to move between a locked and an unlocked state.

From the foregoing, it should be appreciated that the present invention also contemplates a method of supporting a binding of a boot on a support surface of the snowboard. This method encompasses any of the steps inherent in the above described structure. Broadly, the method includes providing a coupling member having a top surface that is securable to the binding and a bottom surface opposite the top surface. The coupling member is placed so that the bottom surface confronts the support surface of the snowboard. The coupling member is constrained for rotation about a rotational axis that is perpendicular to this support surface while maintaining the bottom surface of the coupling member in a confronting relationship to the support surface. The binding is then secured to the coupling member. This method may also include the steps of selectively locking the coupling member in a first rotational position and permitting rotation between the first rotational and a second rotational position.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

I claim:

1. An apparatus for snow riding by a rider wearing boots, comprising:
(A) an elongate snowboard having a longitudinal board axis, an upper surface adapted to support the rider and a lower surface opposite the upper surface, said snowboard including,
(1) a first set of attachment bores formed in the upper surface, and
(2) a second set of attachment bores formed in the upper surface at a location longitudinally spaced from the first set of attachment bores;
(B) a first binding adapted to receive a first boot of the rider,
(1) said first binding being fixedly attached to the upper surface of said snowboard by means of first fasteners that are received by at least some of said attachment bores in said first set;
(C) a second binding adapted to receive a second boot of the rider wherein said second boot includes a longitudinal boot axis; and
(D) a mount disposed on the support surface in spaced relation to said first binding, said mount including
(1) a base member formed as a plate having a plurality of positioning holes extending therethrough and arranged in an array,
(a) said base member fixedly attached to the upper surface of said snowboard by means of second fasteners received by at least some of the positioning holes and that are received in at least some of said attachment bores in said second set,
(2) a coupling member associated with said base member,
(a) said coupling member having a plurality of openings adapted to receive third fasteners,
(b) said second binding being attached to said coupling member by means of said third fasteners that are received in at least some of the openings in said coupling member,
(c) said coupling member being movably disposed relative to said base member such that the rider may relatively orient said coupling and said base member between
(i) a primary position wherein the longitudinal boot axis is transverse to the longitudinal board axis when the second boot is secured in said second boot binding, and
(ii) a secondary position wherein the longitudinal boot axis is generally parallel to the longitudinal board axis when the second boot is secured in said second boot binding; and
(3) a latch associated with said base member and said coupling member, said latch being movable between
(a) a locked state to lock said coupling member and said base member against relative movement when said coupling is in the primary position, and
(b) an unlocked state thereby to permit the rider to move said coupling member between the primary boot position and the secondary position.

2. An apparatus according to claim 1 wherein said coupling member, said base member, and said latch are formed of a material chosen from metal, plastic, and a combination of metal and plastic.

3. An apparatus according to claim 1 wherein the array of positioning holes permits said base member to be mounted in at least two different orientations relative to the longitudinal axis of said snowboard.

4. An apparatus according to claim 1 wherein the array of positioning holes permits said base member to be mounted in at least three different orientations relative to the longitudinal axis of said snowboard.

5. An apparatus according to claim 1 wherein
(A) said coupling member is a disc-shaped plate, and
(B) said base member is a plate having a circular cavity formed therein that is sized and adapted to receive said coupling member in a nested state.

6. An apparatus according to claim 5 wherein said coupling member and said base member are coplanar flat plates when in the nested state.

7. An apparatus according to claim 1 wherein said base member has a first latch bore and said coupling member has a second latch bore, said first and second latch bores positioned to coaxially align with one another when said base member and said coupling member are in the primary position, said latch including a movable rod disposed in the first latch bore and operative to extend into the second latch bore when in the locked state.

8. An apparatus according to claim 7 wherein said rod is biased toward the locked state.

9. An assembly adapted to secure to a support surface of a snowboard that is adapted to support a rider wearing a boot, comprising:
(A) a base member adapted to affix to the support surface of the snowboard thereby to define a mounted state,
(1) said base member having a circular opening formed therein and including a radially inwardly projecting flange;
(B) a disc-shaped coupling member rotatably disposed in the circular opening in said base member to define a nested state,
(1) said coupling member operative to engage said flange and having
(2) a bottom surface adapted to confront the upper surface of the snowboard whereby a perimeter margin of said coupling member is secured between said flange and the snowboard when in the nested and mounted states, and
(C) a binding adapted to be mounted to said coupling member and operative to receive a boot of the rider.

10. An assembly according to claim 9 wherein said base member is formed as a flat plate, said coupling member and said base member each having top and bottom surfaces with the top surfaces being coplanar with one another and the bottom surfaces being coplanar with one another when in the nested state.

11. An assembly according to claim 9 wherein the perimeter margin of said coupling member is formed as an outwardly projecting lip that provides a shoulder that engages said flange when in the nested state.

12. An assembly according to claim 9 wherein said coupling member and said base member are formed of a material chosen from metal, plastic, and a combination of metal and plastic.

13. An assembly according to claim 9 including a latch associated with said base member and said coupling member, said latch being
(A) operative in a locked state to lock said coupling member and said base member against relative rotation when said coupling member is in a primary position, and
(B) movable to an unlocked state thereby to permit relative rotation between said coupling member and said base member to a secondary position.

14. An assembly according to claim 13 wherein said base member has a first latch bore and said coupling member has a second latch bore, the first and second latch bores positioned to co-axially align with one another when said base member and said coupling member are in the first position, said latch including a movable rod disposed in the first latch bore and operative to extend into the second latch bore when in the locked state.

15. An assembly according to claim 14 wherein the first latch bore has a first portion of a first diameter and first length located adjacent to said coupling member and a second portion of a second diameter that is less than the first diameter and a second length, said rod including an enlarged head portion disposed in the first portion and a shaft portion disposed in the second portion, the second latch bore sized and adapted to receive at least part of said head portion when in the locked state with at least some of said shaft portion projecting outwardly of the second portion of the first latch bore such that it may be grasped by the rider's hand.

16. An assembly according to claim 15 including a spring element disposed in the first portion of said first latch bore and operative to bias said head toward the locked state.

17. An assembly according to claim 9 wherein the openings in said coupling member are threaded, said binding including threaded fasteners adapted to engage the openings.

18. An assembly according to claim 9 wherein said base member has a plurality of positioning holes arranged in an array, there being a first pair of holes oriented along a first line and spaced a selected distance apart from one another, a second pair of holes oriented along a second line and spaced the selected distance apart from one another and a third pair of holes oriented along a third line different from the second line and spaced the selected distance apart from one another, each of said second and third lines being oriented at an angle with respect to the first line whereby the first and second pairs of holes are located at the corners of a first rectangle and whereby the first and third pairs of holes are located at the corners of a second rectangle.

19. A mount adapted to secure to a support surface of a snowboard that is adapted to support a rider wearing a boot and mount a binding for said boot, comprising:
(A) a base member adapted to affix to the support surface of the snowboard thereby to define a mounted state,
(1) said base member having a circular opening formed therein and including a radially inwardly projecting flange; and
(B) a disc-shaped coupling member rotatably disposed in the circular opening in said base member to define a nested state,
(1) said coupling member including an outwardly projecting lip operative to engage said flange and having
(2) a bottom surface adapted to confront the upper surface of the snowboard whereby said lip is located between said flange and the snowboard in the nested and mounted states,
(3) said coupling member having a plurality of openings adapted to receive fasteners for securing the binding thereto.

20. A mount according to claim 19 wherein said coupling member and said base member are formed of a material chosen from metal, plastic, and a combination of metal and plastic.

21. A mount according to claim 19 including a latch associated with said base member and said coupling member, said latch being
(A) operative in a locked state to lock said coupling member and said base member against relative rotation when said coupling member is in a primary position, and
(B) movable to an unlocked state thereby to permit relative rotation between said coupling member and said base member.

22. A mount according to claim 21 wherein said base member has a first latch bore and said coupling member has a second latch bore, the first and second latch bores positioned to coaxially align with one another when said base member and said coupling member are in the primary position, said latch including a movable rod disposed in the first latch bore and operative to extend into the second latch bore when in the locked state.

23. A mount according to claim 22 wherein the first latch bore has a first portion of a first diameter and first length located adjacent to said coupling member and a second portion of a second diameter that is less than the first diameter and a second length, said rod including an enlarged head portion disposed in the first portion and a shaft portion disposed in the second portion, the second latch bore sized and adapted to receive at least part of said head portion when in the locked state with at least some of said shaft portion projecting outwardly of the second portion of the first latch bore such that it may be grasped by the rider's hand.

24. A mount according to claim 23 including a spring element disposed in the first portion of said first latch bore and operative to bias said head toward the locked state.

25. A mount according to claim 19 wherein the openings in said coupling member are threaded.

26. A mount according to claim 19 wherein said base member has a plurality of positioning holes arranged in an array, there being a first pair of holes oriented along a first line and spaced a selected distance apart from one another, a second pair of holes oriented along a second line and spaced the selected distance apart from one another and a third pair of holes oriented along a third line different from the second line and spaced the selected distance apart from one another, each of said second and third lines being oriented at an angle with respect to the first line whereby the first and second pairs of holes are located at the corners of a first rectangle and whereby the first and third pairs of holes are located at the corners of a second rectangle.

27. In a snow riding system for a rider wearing boots including an elongate snowboard having a longitudinal board axis, an upper surface adapted to support the rider and a lower surface opposite the upper surface to glide on a snow covered area wherein said snowboard includes a first set of attachment bores formed in the upper surface, a second set of attachment bores formed in the upper surface at a location longitudinally spaced from the first set of attachment bores, a first binding adapted to receive a first boot of the rider and being fixedly attached to the upper surface of said snowboard by means of first fasteners that are received in at least some of said attachment bores in said first set, a second binding adapted to receive a second boot of the rider wherein said second boot includes a longitudinal boot axis, the improvement comprising a mount adapted to secure said second binding to said snowboard, said mount including
(A) a base member adapted to affix to the support surface of the snowboard by means of second fasteners that are received in at least some of said attachment bores in said second set thereby to define a mounted state,
(1) said base member having a circular opening formed therein and including a radially inwardly projecting flange;
(B) a disc-shaped coupling member rotatably disposed in the circular opening in said base member to define a nested state,
(1) said coupling member including an outwardly projecting lip operative to engage said flange and having
(2) a bottom surface adapted to confront the upper surface of the snowboard whereby said lip is secured between said flange and the snowboard in the coupled state,
(3) said coupling member having a plurality of openings adapted to receive fasteners adapted to secure the second binding thereto; and
(C) a latch associated with said base member and said coupling member, said latch being movable between
(1) a locked state to lock said coupling member and said base member against relative rotation when said coupling is in a primary position, and
(2) an unlocked state thereby to permit relative rotation between said coupling member and said base member.

28. A method of supporting a binding of a boot on a support surface of a snowboard, comprising the steps of:
(A) providing a coupling member having a top surface that is securable to the binding and a bottom surface opposite the top surface;
(B) placing said coupling member so that the bottom surface confronts the support surface of the snowboard;
(C) constraining said coupling member for rotation about a rotational axis that is perpendicular to the support surface while maintaining the bottom surface in confronting relationship to the support surface; and
(D) securing the binding to the coupling member.

29. A method according to claim 28 including the steps of selectively locking the coupling member in a first rotational position and permitting rotation between the first rotational position and a second rotational position.
